(19) United States
(12) Patent Application Publication
(10) Pub. No.: US 2014/0119677 A1
(43) Pub. Date: May 1, 2014

(54) EXPANDABLE BAGS AND METHODS OF FORMING AND USING SAME

(71) Applicant: Automated Packaging Systems, Inc., Streetsboro, OH (US)

(72) Inventor: Hershey Lerner, Aurora, OH (US)

(73) Assignee: Automated Packaging Systems, Inc., Streetsboro, OH (US)

(21) Appl. No.: 14/063,237

(22) Filed: Oct. 25, 2013

Related U.S. Application Data
(60) Provisional application No. 61/719,056, filed on Oct. 26, 2012.

(51) Int. Cl. B65D 33/00; B31B 1/18; B65B 51/10; B31B 1/90; B65B 1/02; B65D 33/24; B31B 23/00; B31B 1/25

(52) U.S. Cl. CPC B65D 33/002; B31B 23/00; B31B 1/18; B31B 1/25; B31B 1/90; B65B 1/02; B65D 33/24; B65B 51/10
USPC 383/37; 493/227; 493/230; 53/456; 53/459; 53/477; 383/63

(57) ABSTRACT

A web of expandable bags, a method for forming a web of expandable bags, and a method of forming an expandable bag containing a product is provided. The web of expandable bags includes a plurality of connected bags. Each bag includes a front ply and a back ply, and each bag is connected to an adjacent bag by a perforated connection. The front and back plies are joined to define a compartment that includes a first side, a second side, a third side that extends between the first side and the second side, and a bag opening that is configured to be closed. The front and back plies include a plurality of slits, and the plurality of slits are arranged in a plurality of spaced apart rows. The plurality of slits allows the compartment to expand in a direction that is perpendicular to the arrangement of the plurality of slits.

### RELATED APPLICATIONS

This application is a Non-Provisional Application of U.S. Provisional Application Ser. No. 61/719,056, filed Oct. 26, 2012, titled “EXPANDABLE BAGS AND METHODS OF FORMING AND USING SAME”, the entire disclosure of which is incorporated by reference in its entirety.

### FIELD OF THE INVENTION

The present application relates generally to packaging and in particular to expandable bags, a web of expandable bags, and methods for forming a web of expandable bags and using the same.

### BACKGROUND

Various types of packaging are well known. Expandable bags are one particular type of packaging that is often used to package items such as produce, for example, grapes or cherries. Generally, such expandable bags include slits that allow air to circulate in the bag for ventilation of the produce, as well as to allow the bag to expand to conform to the shape of the produce.

### SUMMARY

The present application discloses a web of expandable bags, a method for forming a web of expandable bags, and a method of forming an expandable bag containing a product. In an exemplary embodiment, the web of expandable bags includes a plurality of connected bags. Each bag includes a front ply and a back ply, and each bag is connected to an adjacent bag by a perforated connection. The front ply is joined to the back ply to define a compartment that includes a first side, a second side, a third side that extends between the first side and the second side, and a bag opening that is configured to be closed. The front ply and the back ply include a plurality of slits, and the plurality of slits are arranged in a plurality of spaced apart rows. The plurality of slits allows the compartment to expand in a direction that is perpendicular to the arrangement of the plurality of slits.

In an exemplary embodiment of a method for forming a web of expandable bags, the method includes providing a web of preformed bags. The web of preformed bags includes a front ply and a back ply, and each preformed bag includes a compartment having a first side, a second side, and a third side that extends between the first side and the second side, and frangible connections that connect adjacent preformed bags. A plurality of slits are formed in the front ply and back ply of the web of preformed bags, and the plurality of slits are arranged in a plurality of spaced apart rows. In one exemplary embodiment, the web of preformed bags is provided on a supply roll. In another exemplary embodiment, the method further includes collecting the slit web of preformed bags on a rotatable collection roll.

### BRIEF DESCRIPTION OF THE DRAWINGS

FIG. 1 is a schematic illustration of an exemplary expandable bag;

FIG. 1A is a view of the expandable bag taken along lines 1A-1A in FIG. 1;

FIG. 2 is an image of an exemplary expandable bag;

FIG. 2A is an image of the expandable bag of FIG. 2 in an expanded condition;

FIG. 3 is an image of an exemplary expandable bag containing a product;

FIG. 3A is an image of a non-expandable bag containing a product;

FIG. 4 is a schematic illustration of an exemplary expandable bag;

FIG. 4A is a view of the expandable bag taken along lines 4A-4A in FIG. 4;

FIG. 5 is a schematic illustration of an exemplary expandable bag;

FIG. 5A is a view of the expandable bag taken along lines 5A-5A in FIG. 5;

FIG. 6 is a schematic illustration of an exemplary web of expandable bags;

FIG. 7 is a schematic illustration of an exemplary web of expandable bags;

FIG. 8 is a schematic illustration of an exemplary cutting module for forming a web of expandable bags;

FIG. 8A is a view of the exemplary cutting module taken along lines 8A-8A in FIG. 8;

FIG. 9 is a schematic illustration of an exemplary cutting module for forming a web of expandable bags;

FIG. 9A is a view of the exemplary cutting module taken along lines 9A-9A in FIG. 9;

FIG. 10 is a schematic illustration of an exemplary cutting module for forming a web of expandable bags;

FIG. 11 is a schematic illustration of an exemplary apparatus for forming a web of expandable bags;

FIG. 12 is a schematic illustration of an exemplary cutting module for forming a web of expandable bags;

FIG. 13 is a schematic illustration of an exemplary apparatus for loading a product into an expandable bag;

FIG. 13A is a view of the exemplary apparatus taken along lines 13A-13A in FIG. 13;

FIG. 14 is a schematic illustration of an exemplary apparatus for forming a web of expandable bags and for loading a product into an expandable bag;

FIG. 14A is a view of the exemplary apparatus taken along lines 14A-14A in FIG. 14;

FIG. 15 is a schematic illustration of an exemplary apparatus for loading a product into an expandable bag;

FIG. 16 is a schematic illustration of an exemplary web of expandable bags;

FIG. 17 is a schematic illustration of an exemplary apparatus for loading a product into an expandable bag;

FIG. 18 is a schematic illustration of an exemplary reclosable pouch; and

FIG. 18A is a view of the exemplary reclosable pouch taken along lines 18A-18A in FIG. 18.

### DETAILED DESCRIPTION

The present application relates to expandable bags, a web of expandable bags, a method for forming a web of expandable bags, and a method for forming a web of expandable bags containing a product. The expandable bags are particularly useful for packaging various types of consumer products including, but not limited to, fresh produce, such as cherries, grapes, apples, and so forth.

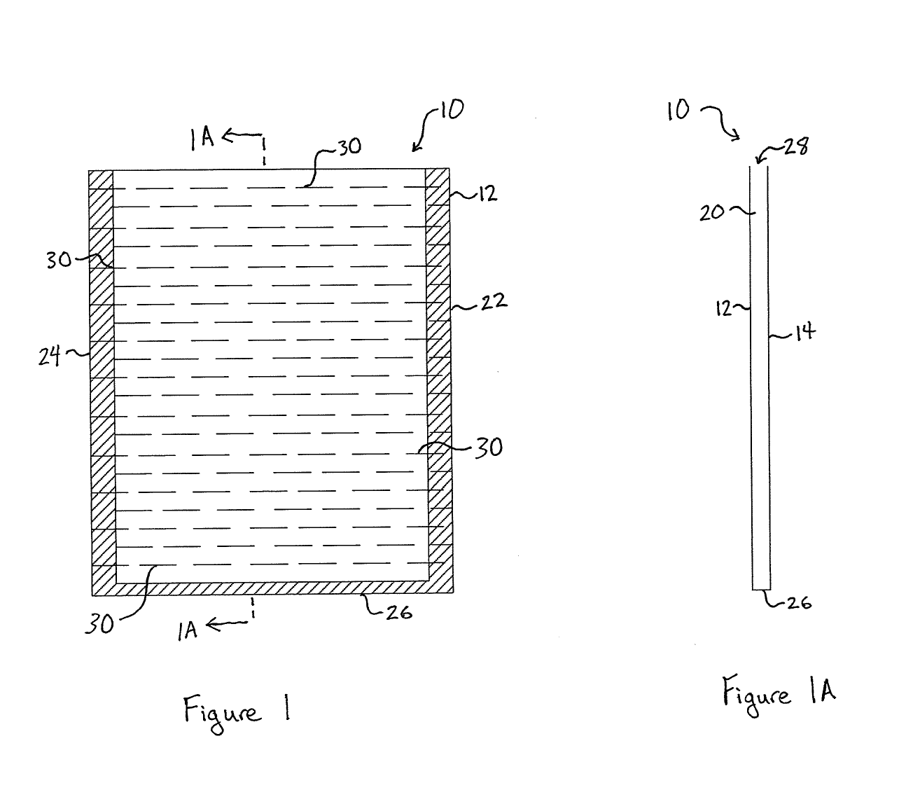

Referring to FIGS. 1 and 1A, an exemplary embodiment of an expandable bag 10 includes a front ply 12 and a back ply 14. The front and back plies 12, 14 may be two separate plies, or a single ply that is folded. As seen in the example, the front ply 12 is joined to the back ply 14 to define a compartment 20 including a first side 22, a second side 24, a third side 26 that extends between the first side 22 and the second side 24, and a bag opening 28 that is configured to be closed. In certain embodiments, the front ply 12 may be joined to the back ply 14 by various techniques including, but not limited to, heat sealing, ultrasonic welding, gluing, etc. Although FIGS. 1 and 1A illustrate the bag 10 as having a single compartment 20, the bag 10 may have any number of compartments.

The front ply 12 and the back ply 14 may be formed of any suitable material. Examples of suitable materials include, but are not limited to, plastic materials, polyethylene, cellophane, vinyl films, pliofilms, cellulose acetate film, polystyrene, polypropylene, and other types of heat sealable or ultrasonic weldable material.

After a product is loaded into the expandable bag 10, the bag opening 28 may be closed in a wide variety of ways. For example, the bag opening 28 may be closed by heat sealing, ultrasonic welding, or gluing together the front and back plies 12, 14. Alternatively, the expandable bag 10 may include a closure device, such as a resealable tongue and groove closure, a snap closure, a zippered closure, a button closure, releasable adhesives, and various other types of closure devices known to those of skill in the art.

With continued reference to FIGS. 1 and 1A, the expandable bag 10 includes a plurality of slits 30 in the front ply 12 and the back ply 14. As seen in FIG. 1, the plurality of slits 30 are arranged in a plurality of spaced apart rows. The plurality of slits 30 allows the compartment to expand in a direction that is perpendicular to the arrangement of the plurality of slits 30. In certain embodiments, the plurality of spaced apart rows of slits 30 are arranged transversely from the first side 22 to the second side 24, as illustrated in FIG. 1. Moreover, in certain embodiments, the slits 30 in adjacent rows are offset, or staggered, in the transverse direction. In other words, in certain embodiments, the slits 30 in alternating transverse rows are substantially aligned, while the slits 30 in adjacent transverse rows are misaligned.

In certain embodiments, the plurality of spaced apart rows of slits 30 may extend to, or even through, the edges of the first and second sides 22, 24, as shown in FIG. 1. In certain other embodiments, the plurality of spaced apart rows of slits 30 may terminate short of the edges of the first and second sides 22, 24. In certain other embodiments, alternative slit patterns are used. Some of these other embodiments are discussed herein.

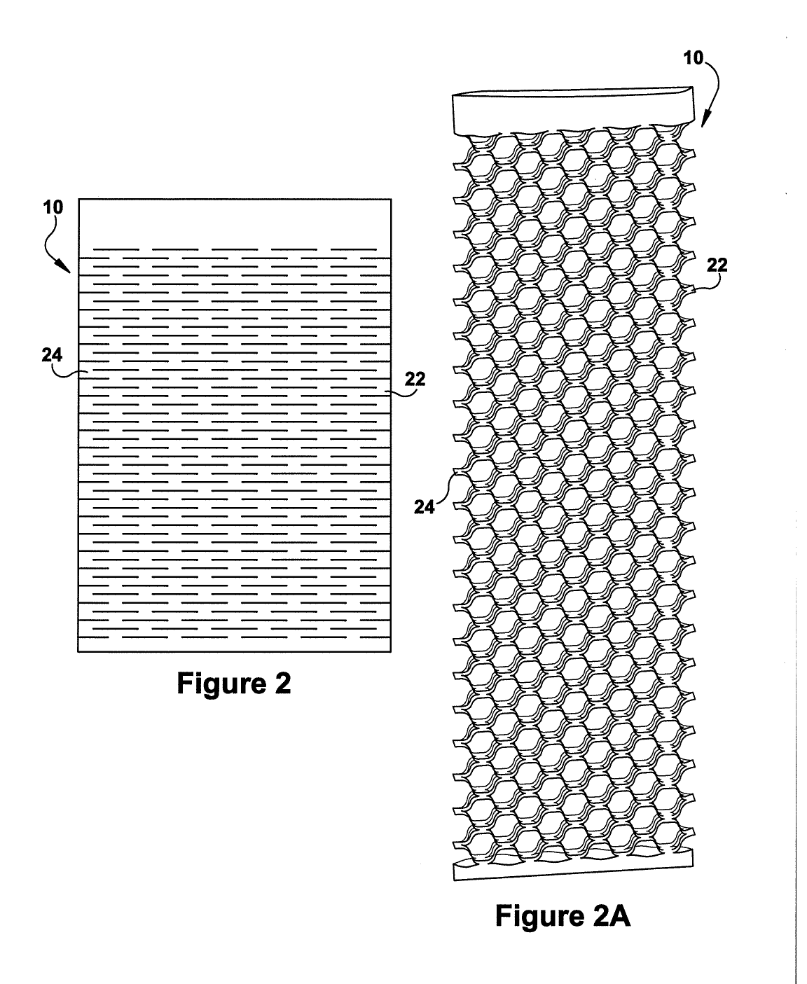

With reference now to FIGS. 2 and 2A, an exemplary expandable bag 10 is shown. Similar to the expandable bag 10 illustrated in FIG. 1, the expandable bag 10 depicted in FIGS. 2 and 2A includes a plurality of spaced apart rows of slits 30 that are arranged transversely from the first side 22 to the second side 24. As mentioned above, the plurality of slits 30 allows the compartment 20 to expand in a direction that is perpendicular to the arrangement of the plurality of slits 30. Thus, the exemplary expandable bag 10 shown in FIG. 2 with a plurality of spaced apart rows of slits 30 arranged transversely from the first side 22 to the second side 24 is capable of expanding longitudinally, as demonstrated in FIG. 2A. Such expandability allows the bag 10 to conform to the shape of the product, as well as to increase the amount of product that can be loaded into the bag 10.

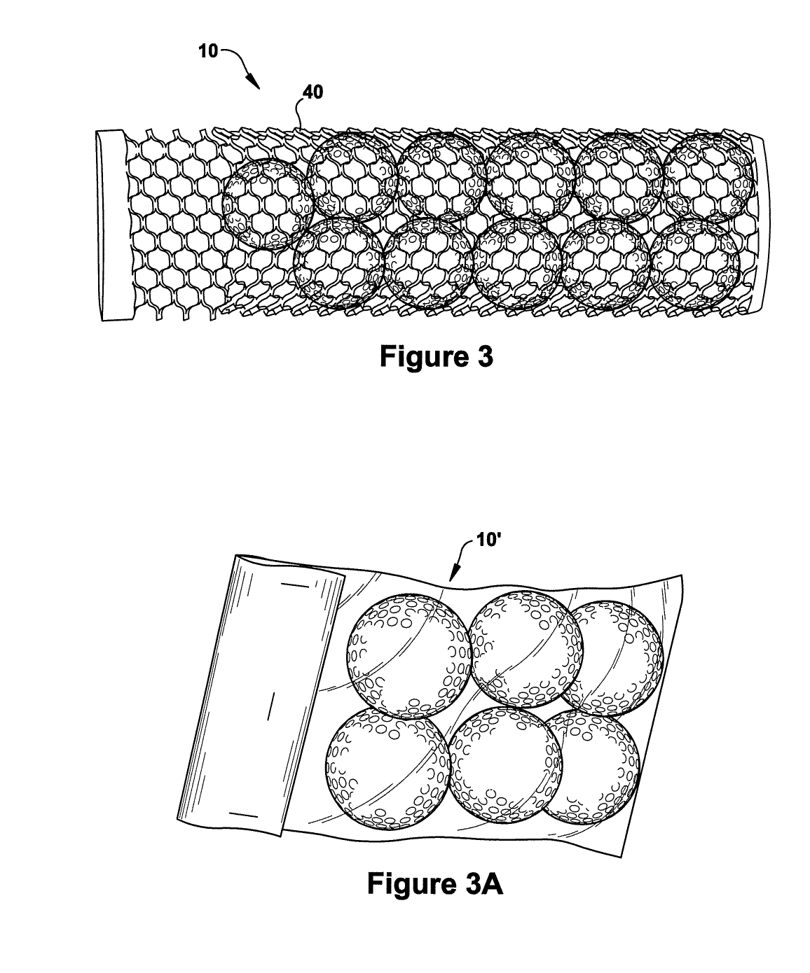

For example, FIGS. 3 and 3A illustrate the increased amount of product 40 (here golf balls) that may be loaded into an expandable bag 10 of FIG. 3 as opposed to a non-expandable bag 10′ of FIG. 3A. As seen in FIG. 3A, the non-expandable bag is able to hold six golf balls. On the other hand, the expandable bag 10 shown in FIG. 3 (which is a bag of the same dimensions as the bag shown in FIG. 3A, however with a plurality of slits 30 formed in the bag) is able to hold eleven golf balls, which is an increase of over 80%. Thus, the expandable bag 10 is able to increase the amount of product that can be contained within the bag 10 without having to increase the dimensions of the bag or the amount of material used to form the bag.

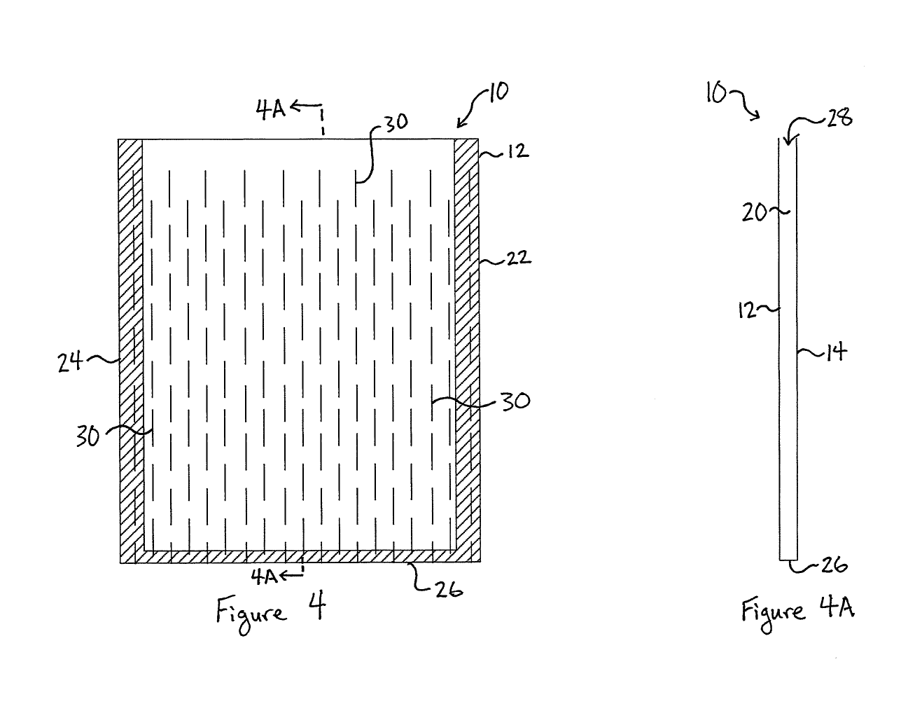

Referring now to FIGS. 4 and 4A, an additional exemplary expandable bag 10 is shown. In this example, the plurality of spaced apart rows of slits 30 are arranged longitudinally from the first side 22 to the second side 24 of the expandable bag 10. In addition, the slits 30 in adjacent rows are offset, or staggered, in the longitudinal direction. In certain embodiments, the plurality of spaced apart rows of slits 30 may extend to, or even through, the edges of the third side 26, as seen in FIG. 4, and the bag opening 28. In certain other embodiments, the plurality of spaced apart rows of slits 30 may terminate short of the third side 26 or the bag opening 28. As previously mentioned, the plurality of slits 30 allows the compartment 20 to expand in a direction that is perpendicular to the arrangement of the plurality of slits 30. Thus, the exemplary expandable bag 10 shown in FIG. 4 with a plurality of spaced apart rows of slits 30 arranged longitudinally from the first side 22 to the second side 24 is capable of expanding transversely.

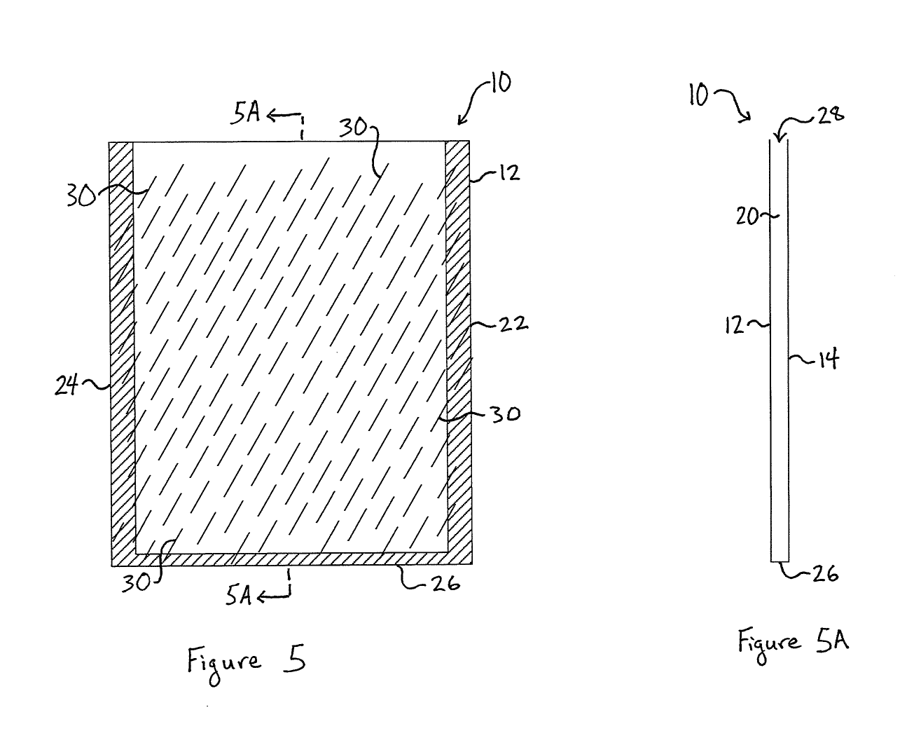

With reference now to FIGS. 5 and 5A, yet another exemplary expandable bag 10 is illustrated. As seen in FIG. 5, the plurality of spaced apart rows of slits 30 are arranged at an acute angle from the first side 22 to the second side 24. In other embodiments, the plurality of spaced apart rows of slits 30 may be arranged at an obtuse angle from the first side 22 to the second side 24. Again, the slits 30 in adjacent rows are offset, or staggered, while the slits 30 in alternating rows are substantially aligned. In certain embodiments, the plurality of spaced apart rows of slits 30 may extend to, or even through, the edges of the first, second, and third sides 22, 24, 26, and the bag opening 28. In certain other embodiments, the plurality of spaced apart rows of slits 30 may terminate short of the first, second, and third sides 22, 24, 26, or the bag opening 28. As discussed, the plurality of slits 30 allows the compartment 20 to expand in a direction that is perpendicular to the arrangement of the plurality of slits 30. In this particular example, the expandable bag 10 is capable of expanding in a substantially diagonal direction.

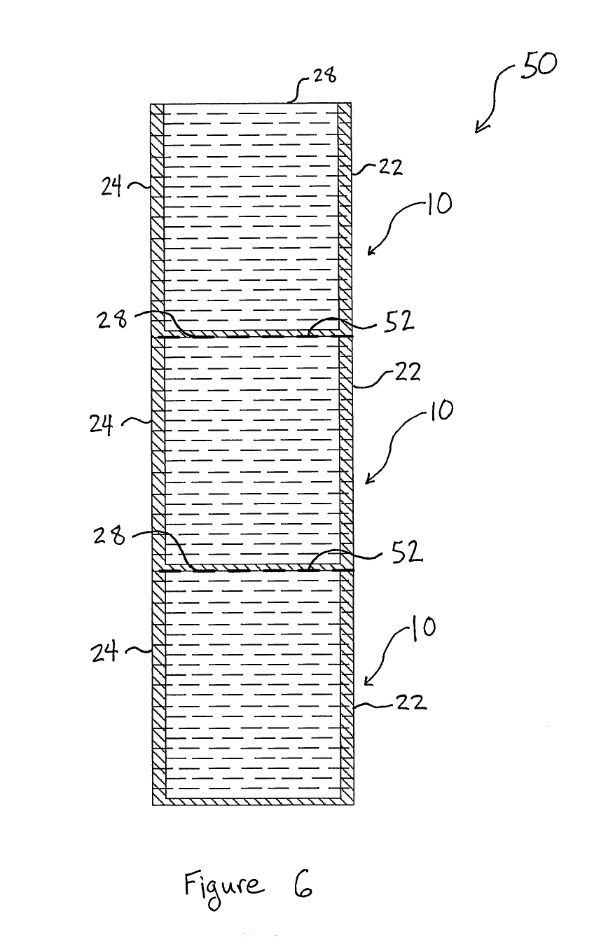

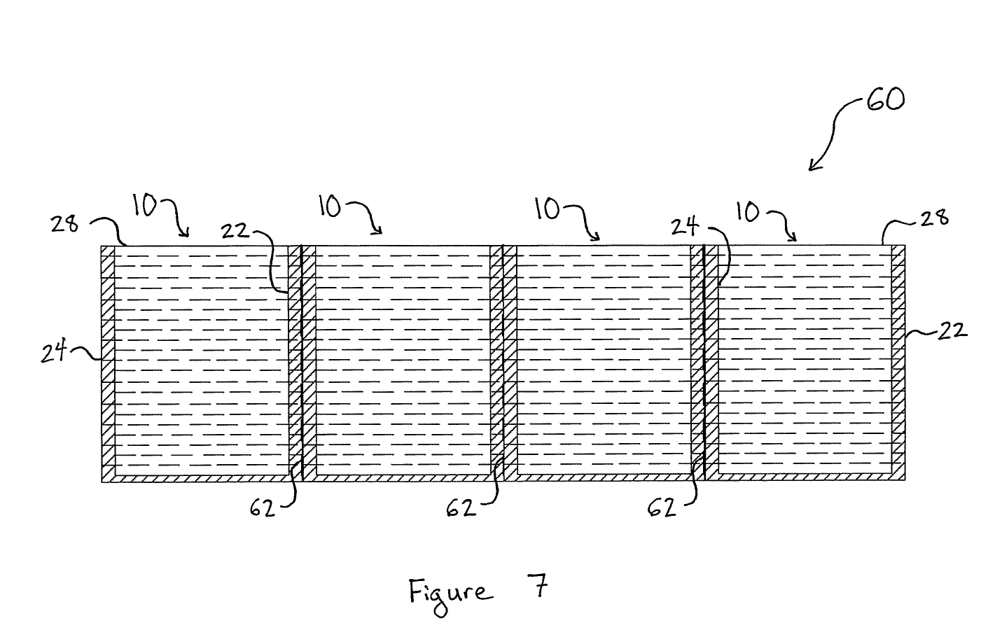

Referring now to FIGS. 6 and 7, exemplary embodiments of a web 50, 60 of expandable bags 10 are shown. The expandable bags 10 illustrated by FIGS. 6 and 7 may be configured in accordance with any of the embodiments disclosed above, or with another alternative embodiment not discussed. Further, the expandable bags 10 illustrated by FIGS. 6 and 7 may include any combination or subcombination of the features of the bags 10 disclosed above. In the examples shown in FIGS. 6 and 7, the web 50, 60 of expandable bags 10 includes a plurality of connected bags 10. In these particular examples, each bag 10 of the web 50, 60 is configured the same as the expandable bag 10 illustrated in FIG. 1. Each bag 10 has a front ply 12 and a back ply 14. As previously mentioned, the front and back plies 12, 14 may be two separate plies, or a single ply that is folded. The front ply 12 is joined to the back ply 14 to define a compartment 20 including a first side 22, a second side 24, a third side 26 that extends between the first side 22 and the second side 24, and a bag opening 28 that is configured to be closed. The web 50, 60 of expandable bags may be formed of a wide variety of materials. For example, the web 50, 60 can comprise a material selected from the group of polyethylene, cellophane, vinyl films, pliofilms, cellulose acetate film, polystyrene, polypropylene, and combinations thereof. Each expandable bag 10 includes a plurality of slits 30 in the front ply 12 and the back ply 14. As discussed above, the plurality of slits 30 are arranged in a plurality of spaced apart rows, which may be oriented in a wide variety of configurations. The plurality of slits 30 allows the compartment 20 to expand in a direction that is perpendicular to the arrangement of the plurality of slits 30.

In addition, each bag 10 of the web 50, 60 of expandable bags 10 is connected to an adjacent bag 10 by a perforated connection 52, 62. The perforated connection 52, 62 is configured to allow controlled separation of the bags 10 from one another. In the exemplary embodiment shown in FIG. 6, the web 50 of expandable bags 10 is configured such that a top end of each bag 10 is connected to a bottom end of the adjacent bag 10 by the perforated connection 52 (“top-to-bottom” connected bags), or vice versa. In the exemplary embodiment illustrated in FIG. 7, the web 60 of expandable bags 10 is configured such that the first side of each bag 10 is connected to the second side of the adjacent bag 10 by the perforated connection 62 (“side-to-side” connected bags), or vice versa. The particular configuration of the web 50, 60 of expandable bags 10 makes the web 50, 60 well suited for use with certain types of packaging machines, as will be discussed in more detail below.

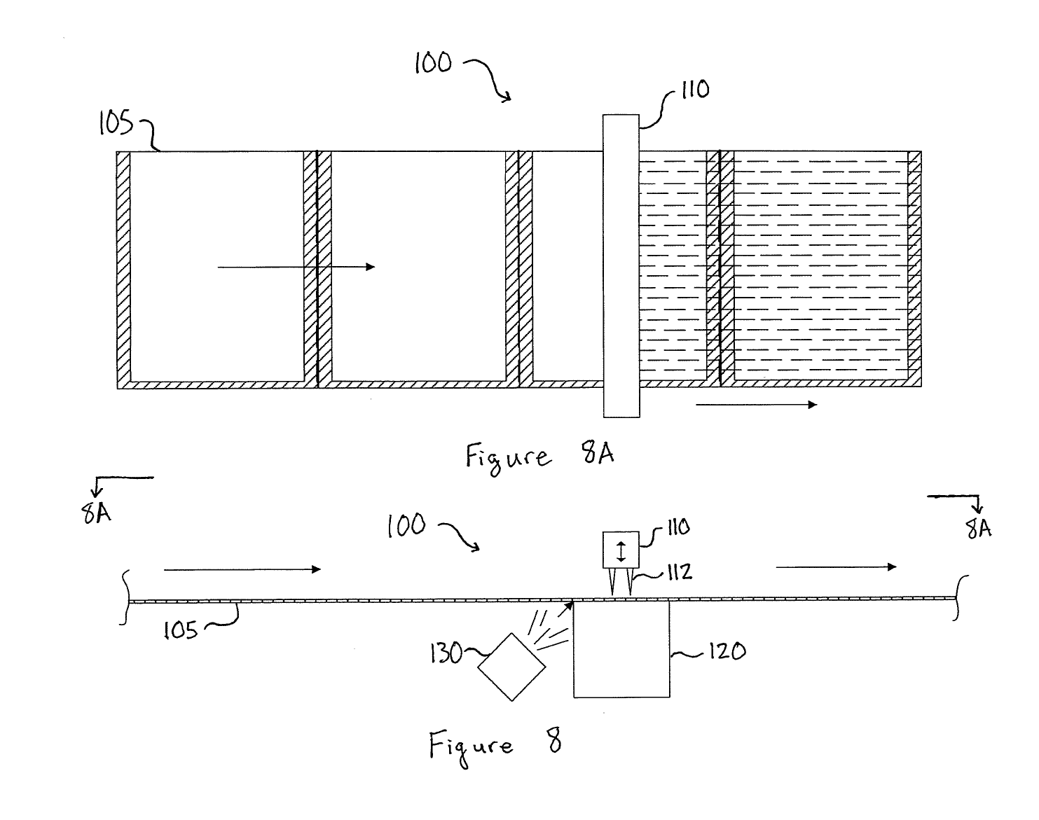

In an exemplary embodiment, a method of forming a web of expandable bags includes providing an unslit web 105 of preformed bags, as seen in FIGS. 8 and 8A. In certain embodiments, the unslit web 105 of preformed bags is provided on a supply roll or in a folded state. The unslit web 105 of preformed bags includes a front ply and a back ply. As previously described the front and back plies may be two separate plies, or a single ply that is folded, or a flattened tube of material. The front and back plies may be joined together by a wide variety of techniques including, but not limited to, heat sealing, ultrasonic welding, gluing, etc. When the front and back plies are joined together, each preformed bag of the web 105 includes a compartment having a first side, a second side, and a third side that extends between the first side and the second side. In addition, the unslit web 105 of preformed bags includes a plurality of frangible connections that connect adjacent preformed bags, and are configured to permit controlled separation of the preformed bags from one another. In certain embodiments, the frangible connections are lines of perforations.

The unslit web 105 of preformed bags may be formed of a wide variety of materials. For example, the web 105 can comprise a material selected from the group of polyethylene, cellophane, vinyl films, pliofilms, cellulose acetate film, polystyrene, polypropylene, and combinations thereof.

In another step of the exemplary method for forming a web of expandable bags, a plurality of slits is formed in or on the front ply and the back ply of the web 105 of preformed bags. The plurality of slits are arranged in a plurality of spaced apart rows. In certain embodiments, the plurality of slits are formed by a cutting module 100.

As seen in FIGS. 8 and 8A, the cutting module 100 includes a movable cutter 110 having a plurality of spaced apart cutting blades 112. The cutting blades 112 may be configured in a variety of ways to provide a variety of slit arrangements and predetermined slit patterns. For example, in certain embodiments, the cutting blades 112 can be configured to form slits in the web 105 of preformed bags corresponding to a machine direction, or a direction of travel of the web 105 (as indicated by the directional arrows), as seen in FIG. 8A. With this exemplary cutting blade 112 orientation, if the web 105 of preformed bags is configured such that the bags are connected side-to-side, then the plurality of spaced apart rows of slits will be formed in the bags transversely from the first side to the second side. Alternatively, if the web 105 of preformed bags is configured such that the bags are connected top-to-bottom, then the plurality of spaced apart rows of slits will be formed in the bags longitudinally from the first side to the second side.

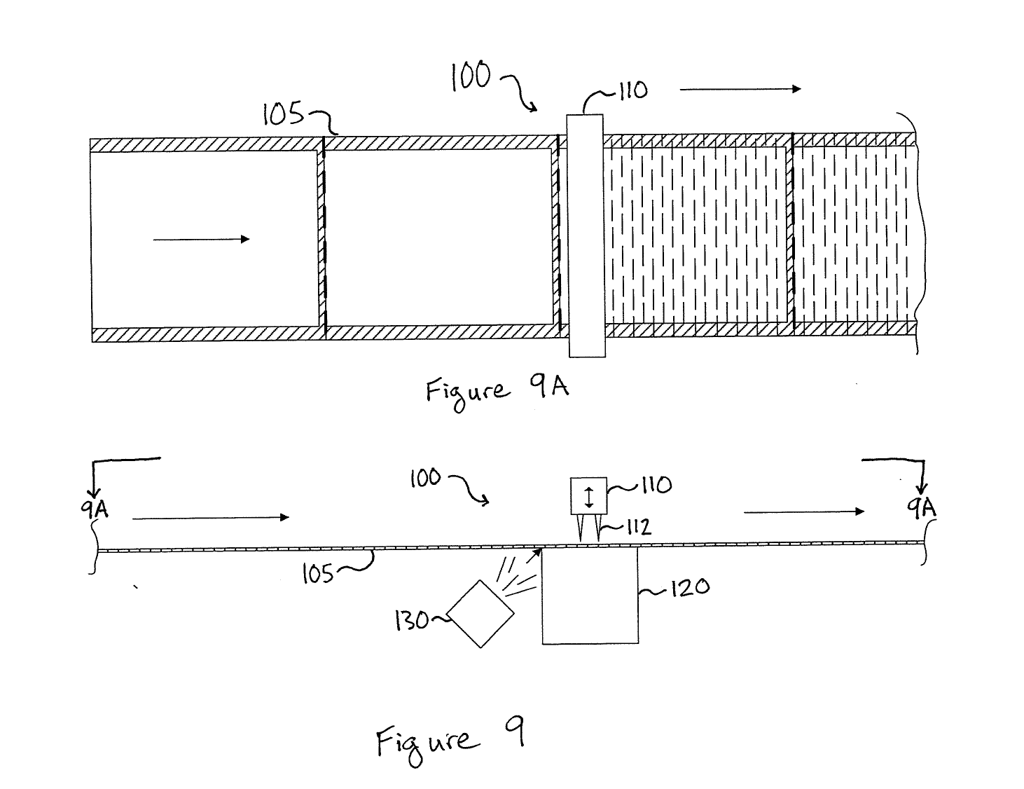

In certain other embodiments, the cutting blades 112 are configured to form slits in the web 105 of preformed bags corresponding to a cross direction, or perpendicular to the direction of travel of the web 105 (as indicated by the directional arrows), as seen in FIG. 9A. With the exemplary cutting blade 112 orientation of FIG. 9A, if the web 105 of preformed bags is configured such that the bags are connected side-to-side, then the plurality of spaced apart rows of slits will be formed in the bags longitudinally from the first side to the second side. Alternatively, if the web 105 of preformed bags is configured such that the bags are connected top-to-bottom, then the plurality of spaced apart rows of slits will be formed in the bags transversely from the first side to the second side, as shown in FIG. 9A.

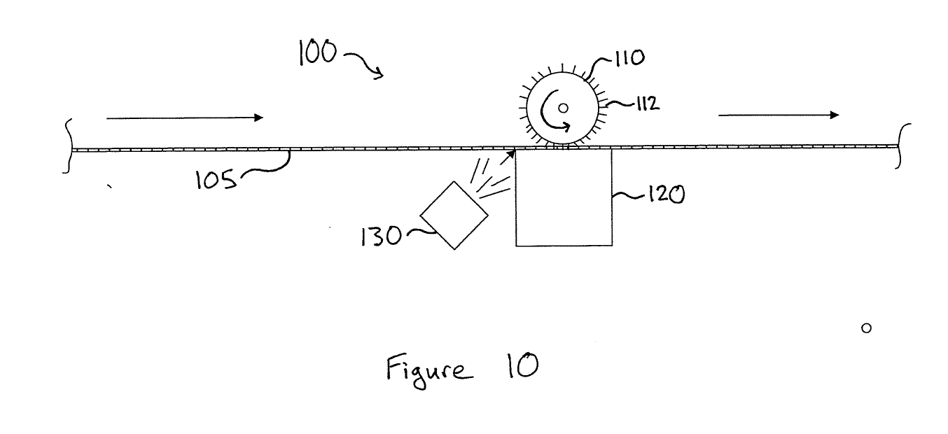

The movable cutter 110 may operate in a number of ways. As seen in FIGS. 8 and 9, in certain embodiments, the movable cutter 110 is configured to move the plurality of cutting blades 112 with a linear reciprocating motion (i.e., up and down) to form the plurality of spaced apart rows of slits in the web 105. Alternatively, in certain embodiments, the movable cutter 110 is configured as a cutting roll having a plurality of spaced apart cutting blades 112 circumferentially arranged on the cutting roll, as seen in FIG. 10. Thus, in the exemplary movable cutter 110 illustrated in FIG. 10, the movable cutter 110 rotates the plurality of cutting blades 112 to form the plurality of spaced apart rows of slits in the web 105.

The cutting module 100 also includes a web support 120, as seen in FIGS. 8, 9, and 10. The web support 120 provides support to the web 105 of preformed bags as the movable cutter 110 forms slits in the web 105 of preformed bags. The web support 120 may be formed from a wide variety of materials. For example, the web support 120 can comprise a foam material, a rubber material, or a plastic material. The web support 120 should have a level of resiliency, but should not be too hard as to cause premature wear of the cutting blades 112.

With continued reference to FIGS. 8, 9, and 10, the cutting module 100 includes a blower 130. As the movable cutter 110 forms slits in the web 105 of preformed bags, the web 105 has a tendency to adhere to the web support 120. The blower 130 functions to separate the slit web of preformed bags from the web support 120, which helps reduce possible resistance created by adherence of the web 105 to the web support 120.

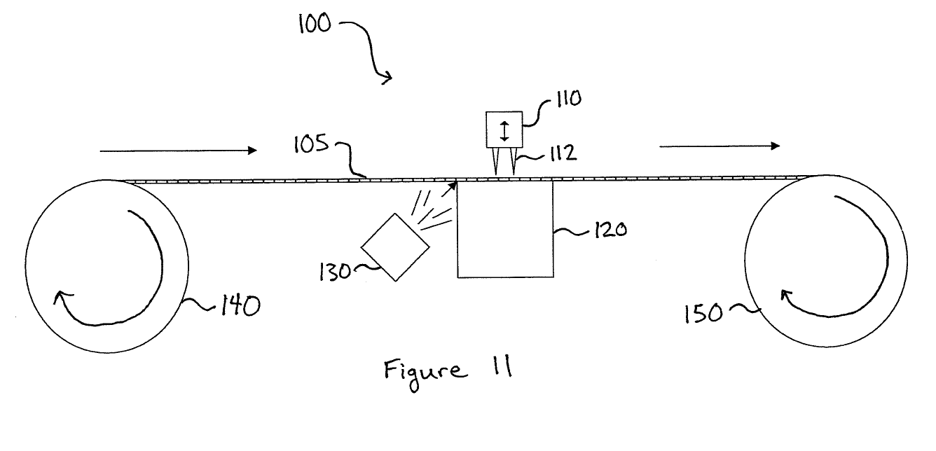

Turning now to FIG. 11, in certain embodiments, the cutting module 100 may be configured as a standalone apparatus for forming a web of expandable bags. As seen in FIG. 11, the cutting module includes a movable cutter 110, a web support 120, and a blower 130 as previously described. An unslit web 105 of preformed bags is provided on a supply roll 140, although in certain embodiments the web 105 of preformed bags may be provided in a folded state. The web 105 of preformed bags may be side-to-side connected bags or top-to-bottom connected bags. As illustrated in FIG. 11, the web 105 of preformed bags is fed to the movable cutter 110 from the supply roll 140. After the web 105 is fed through the movable cutter 110 and the plurality of slits are formed in or on the web 105, the slit web of preformed bags is collected on a rotatable collection roll 150. In certain embodiments, a portion of the web 105 from the supply roll 140 may be wound around the collection roll 150 prior to feeding the remainder of the web 105 to the movable cutter 110. In addition, the rotation of the collection roll 150 places tension on the web 105 and facilitates feeding the web 105 through the movable cutter. Collecting the slit web of preformed bags on a collection roll 150 facilitates the use of the slit web of preformed bags in packaging operations, as well as other uses such as a roll of separable, slit produce bags that may be readily placed in the produce section of supermarkets.

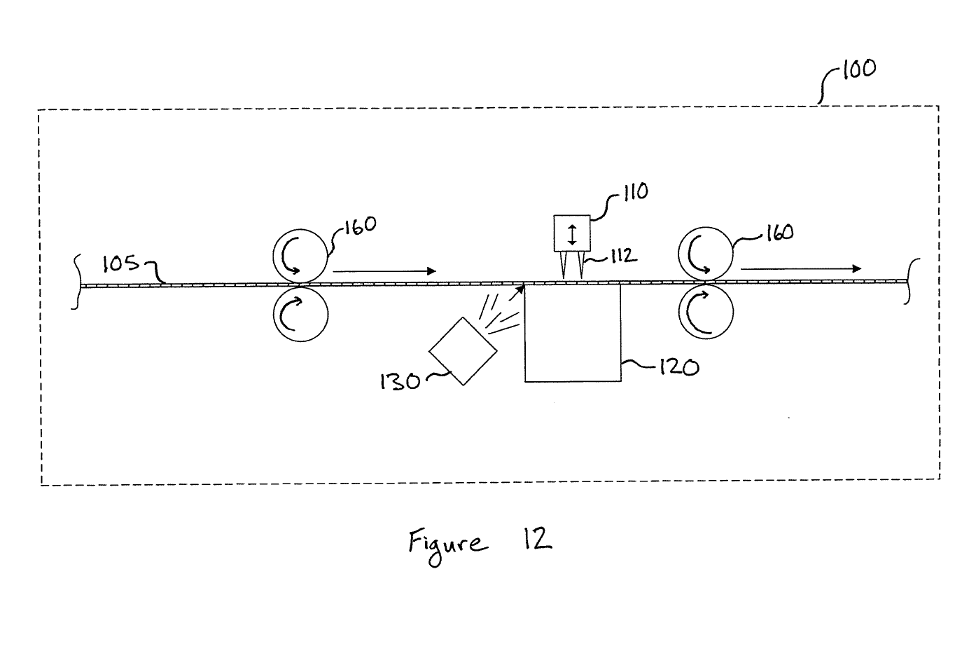

Referring now to FIG. 12, in certain embodiments the cutting module 100 may be configured as an in-line bag cutting device that may be incorporated into a packaging apparatus or system. The cutting module 100 includes a movable cutter 110, a web support 120, and a blower 130 as previously described. In addition, in certain embodiments, the cutting module 100 includes one or more pairs of nip rolls 160 that are counter rotated to feed the web 105 through the cutting module 100.

In an exemplary embodiment, a method of forming an expandable bag containing a product includes providing a supply of connected bags. In certain embodiments, the supply of connected bags is provided on a supply roll or in a folded state. The supply of connected bags includes a front ply and a back ply. As previously described the front and back plies may be two separate plies, or a single ply that is folded, or a flattened tube of material. The front and back plies may be joined together by a wide variety of techniques including, but not limited to, heat sealing, ultrasonic welding, gluing, etc. When the front and back plies are joined together, each bag includes a compartment having a first side, a second side, and a third side that extends between the first side and the second side. In certain embodiments, each bag has a bag opening that is configured to be closed, as previously described. In certain embodiments, the supply of connected bags includes a plurality of frangible connections that connect adjacent bags, and are configured to permit controlled separation of the bags from one another. In certain embodiments, the frangible connections are lines of perforations. The supply of connected bags may be formed of a wide variety of materials. For example, the supply of connected bags may comprise material selected from the group of polyethylene, cellophane, vinyl films, pliofilms, cellulose acetate film, polystyrene, polypropylene, and combinations thereof.

In another step of the exemplary method for forming an expandable bag containing a product, a plurality of slits is formed in or on the front ply and the back ply of the supply of connected bags. The plurality of slits are arranged in a plurality of spaced apart rows. In certain embodiments, the plurality of slits are formed by a cutting module 100, as previously described. Alternatively, in certain embodiments, the supply of connected bags may be provided as a supply of pre-cut, or pre-slit, connected bags. As previously mentioned, the plurality of spaced apart rows of slits in the bags may be arranged in a variety of ways. For example, the plurality of spaced apart rows of slits can be arranged transversely from the first side to the second side, or alternatively, the plurality of spaced apart rows of slits can be arranged longitudinally from the first side to the second side.

A next step in the exemplary method includes loading a product into the compartment through the bag opening. The loading step may be performed manually or via an automated process. After the product is loaded into the compartment, the next step in the method includes closing the bag opening. As mentioned above, the bag opening may be closed in a variety of ways. For example, the bag opening can be closed by utilizing various techniques known to those of skill in the art including, but not limited to, heat sealing, ultrasonic welding, gluing, etc. In certain embodiments, the bag opening is closed by heat sealing the front ply to the back ply. In a further step of the method, after the bag opening has been closed to retain the product therein, the closed bag may be separated from the supply of bags. The separating step may be performed manually or via an automated process.

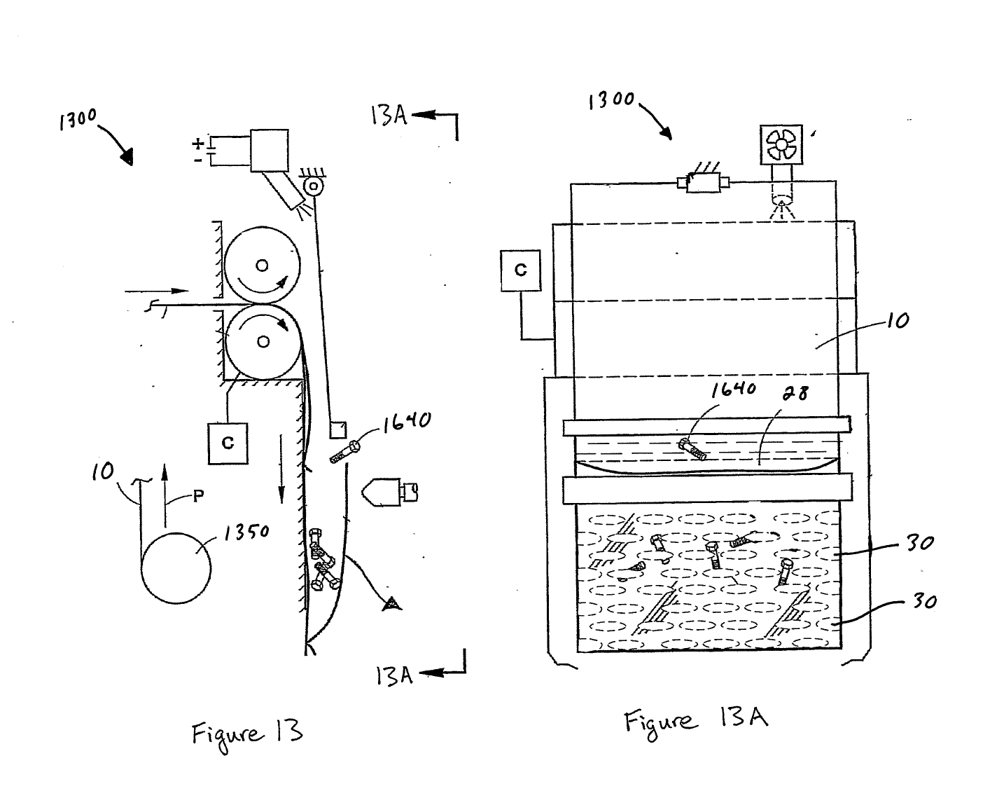

With reference now to FIGS. 13 and 13A, an exemplary packaging apparatus 1300 for executing the method for forming an expandable bag containing a product is shown. The exemplary packaging apparatus is shown and described in detail in U.S. Pat. Nos. 7,654,064 and 8,069,635 to Riccardi et al., which are incorporated herein by reference in their entirety. As seen in FIG. 13, a supply 1350 of pre-cut, connected bags 10 is fed to the packaging apparatus, which facilitates loading a product 1640 into the bag opening 28, closing the bag opening after the product has been loaded into the compartment, and separating the closed bag from the supply of pre-cut, connected bags. When the exemplary packaging apparatus of FIGS. 13 and 13A is utilized, the supply of pre-cut, connected bags is configured as a web of top-to-bottom connected bags, such as the web illustrated in FIG. 6.

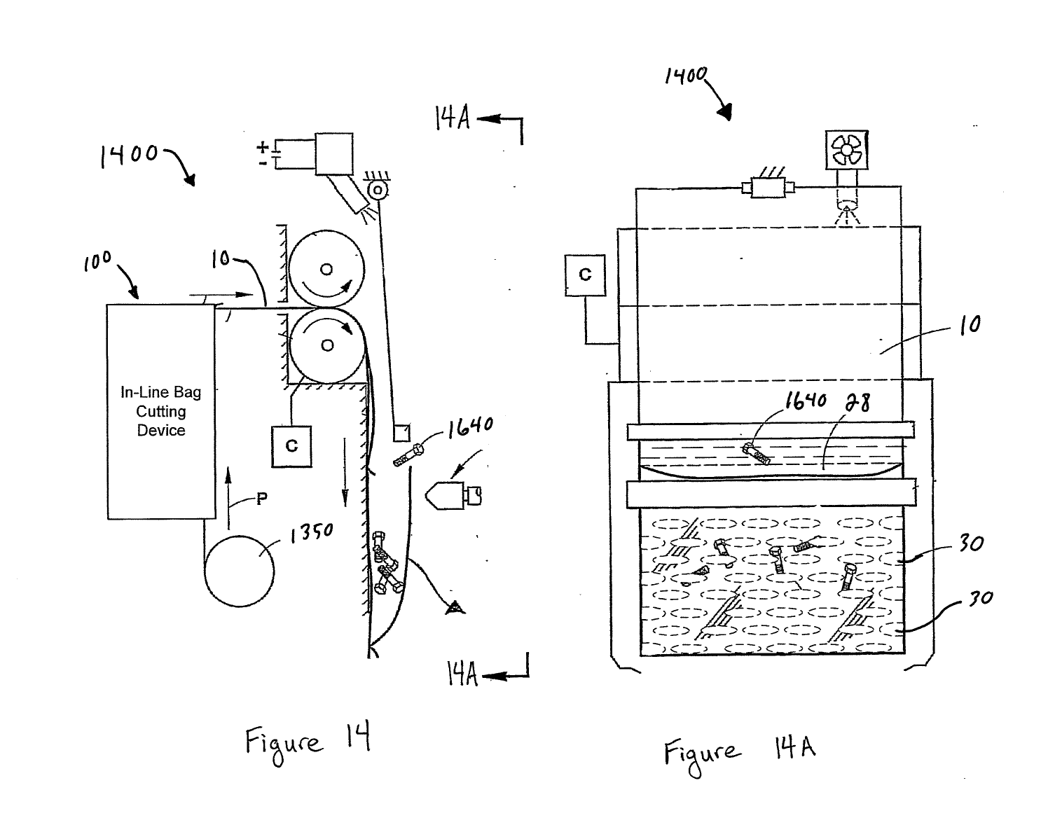

Turning now to FIGS. 14 and 14A, an exemplary packaging apparatus 1400 for executing the method for forming an expandable bag containing a product is shown. In this particular embodiment, the supply 1350 of connected bags supplied to the packaging apparatus 1400 have not been cut or slit. To form the plurality of spaced apart rows of slits 30, the supply of connected bags are fed to an in-line bag cutting device, such as the cutting module 100 as described with reference to FIG. 12. With the exception of the cutting module, the exemplary packaging apparatus of FIGS. 14 and 14A is shown and described in detail in U.S. Pat. Nos. 7,654,064 and 8,069,635 to Riccardi et al. After the supply of connected bags have been cut by the in-line cutting device, the supply of cut, connected bags is fed to the packaging apparatus, which facilitates loading a product into the bag opening, closing the bag opening after the product has been loaded into the compartment, and separating the closed bag from the supply of pre-cut, connected bags. When the exemplary packaging apparatus of FIGS. 14 and 14A is utilized, the supply of connected bags is configured as a web of top-to-bottom connected bags.

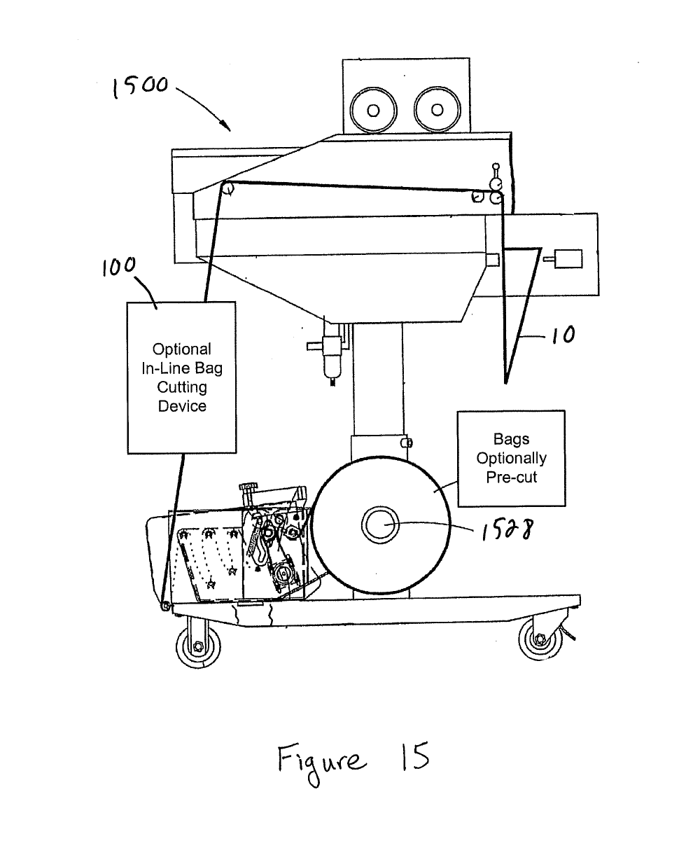

An additional exemplary packaging apparatus 1500 for executing the method for forming an expandable bag containing a product is illustrated in FIG. 15. The exemplary packaging apparatus is shown and described in detail in U.S. Pat. No. 6,742,317 to Cronauer et al., which is incorporated herein by reference in its entirety. As seen in FIG. 15, in an exemplary embodiment, a supply 1528 of pre-cut, connected bags 10 is fed to the packaging apparatus. Alternatively, in other embodiments, the supply of connected bags supplied to the packaging apparatus have not been cut or slit. Thus, to form the plurality of spaced apart rows of slits, the supply of connected bags are fed to an in-line bag cutting device, such as the cutting module 100 as described with reference to FIG. 12. The packaging apparatus 1500 facilitates loading a product into the bag opening, closing the bag opening after the product has been loaded into the compartment, and separating the closed bag from the supply of connected bags. When the exemplary packaging apparatus 1500 of FIG. 15 is utilized, the supply of connected bags, or optionally pre-cut, connected bags 10, is configured as a web of top-to-bottom connected bags, such as the web illustrated in FIG. 6.

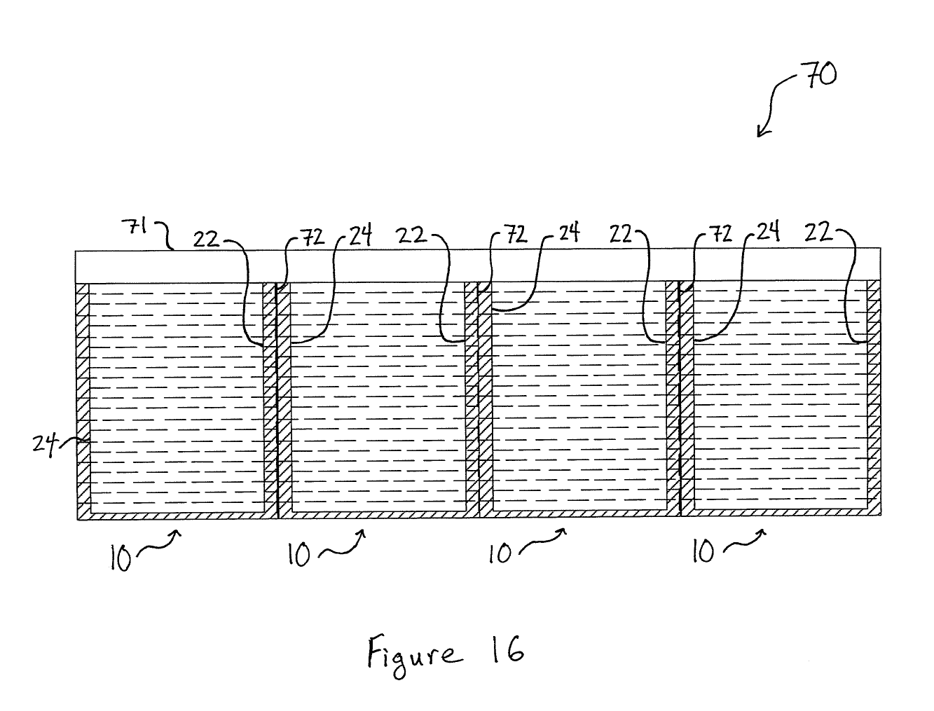

As seen in the example shown in FIG. 16, a web 70 of expandable bags 10 is configured such that the first side 22 of a first expandable bag 10 is adjacent to the second side of a second expandable bag 10 (i.e., the expandable bags 10 are connected side-to-side). The web 70 of expandable bags 10 are connected to one another by, and are configured to be separated from one another along, a line of weakness 72, such as a line of perforations. As seen in FIG. 16, each line of weakness 72 extends the entire length of the sealed first and second sides 22, 24 to promote controlled separation of each expandable bag 10. As previously described, the web 70 may be supplied on a roll or in a folded state for use with a packaging machine that loads a product into each expandable bag 10. In certain embodiments, the sealed first side 22 and sealed second side 24 may extend along the entire width of the web 70, whereas in other embodiments, the sealed first side 22 and sealed second side 24 do not extend the entire width of the web 70. The front and back plies 12, 14 may be sealed or otherwise connected at a top portion 71 of the web 70.

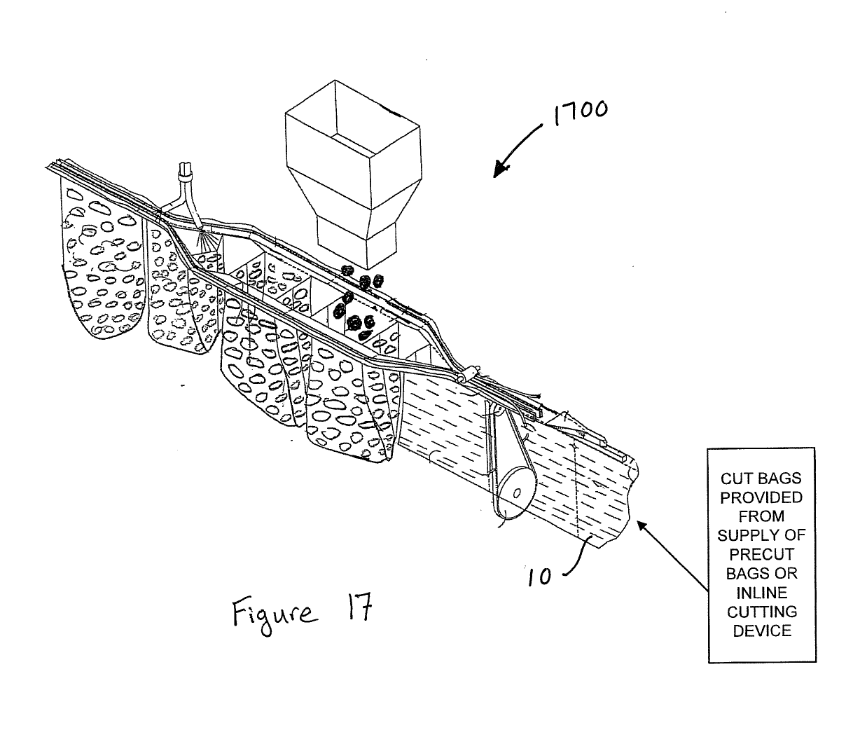

An additional exemplary packaging apparatus 1700 for executing the method for forming an expandable bag containing a product is illustrated in FIG. 17. The exemplary packaging apparatus is shown and described in detail in U.S. Pat. No. 6,035,611 to Lerner, which is incorporated herein by reference in its entirety. As seen in FIG. 17, in an exemplary embodiment, a supply of pre-cut, connected bags 10 is fed to the packaging apparatus 1700. Alternatively, in other embodiments, the supply of connected bags supplied to the packaging apparatus have not been cut or slit. Thus, to form the plurality of spaced apart rows of slits, the supply of connected bags are fed to an in-line bag cutting device, such as the cutting module 100 as described with reference to FIG. 12. The packaging apparatus facilitates loading a product into the bag opening, closing the bag opening after the product has been loaded into the compartment, and separating the closed bag from the supply of connected bags. When the exemplary packaging apparatus of FIG. 17 is utilized, the supply of connected bags, or optionally pre-cut, connected bags, is configured as a web of side-to-side connected bags, such as the web illustrated in FIG. 16.

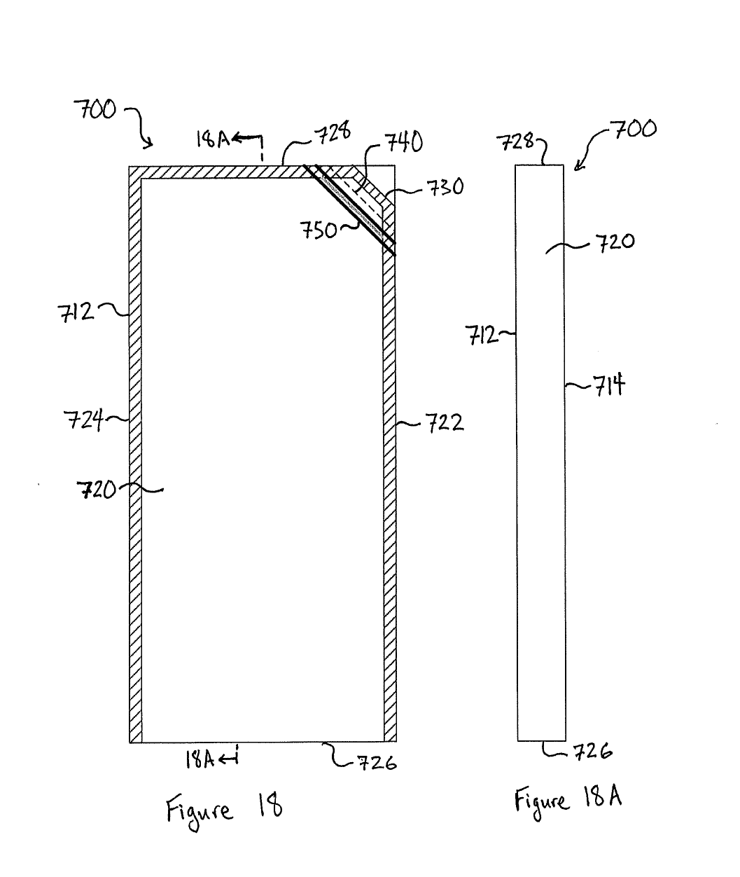

Referring now to FIGS. 18 and 18A, an exemplary reclosable pouch 700 is shown. The reclosable pouch 700 comprises a front ply 712 and a back ply 714. The front ply 12 and the back ply 714 may be formed of any suitable material. Examples of suitable materials include, but are not limited to, plastic materials, polyethylene, cellophane, vinyl films, pliofilms, cellulose acetate film, polystyrene, polypropylene, combinations thereof, and other types of heat sealable or ultrasonic weldable material. The reclosable pouch 700 is particularly useful for packaging various types of liquids, gels, and powders, including but not limited to, liquids, gels, and powders that are intended for consumption by a human or other animal.

The front and back plies 712, 714 may be two separate plies, or a single ply that is folded. As seen in the example, the front ply 712 is joined to the back ply 714 to define a compartment 720 having a perimeter. The perimeter may have various shapes such as, for example, circular, or may have any number of distinct sides. In the exemplary embodiment shown in FIG. 18, the perimeter is defined by a first side 722, a second side 724, a third side 726 extending between the first and second sides 722, 724, a fourth side 728 extending between the second side 724 and a fifth side 730, and the fifth side 730 extending between the first side 722 and the fourth side 728. In certain embodiments, the front ply 712 may be joined to the back ply 714 by various techniques including, but not limited to, heat sealing, ultrasonic welding, gluing, etc. In some embodiments, the front ply 712 is hermetically sealed to the back ply 714.

The reclosable pouch 700 also includes a line of weakness 740 in the front ply 712 and the back ply 714. In certain embodiments, the line of weakness 740 is a line of perforations. As seen in FIG. 18, the line of weakness 740 extends from a first point on the perimeter to a second point on the perimeter, and the line of weakness 740 is spaced inwardly toward the compartment 720 from the perimeter. With this particular configuration, a user can gain access to the contents of the compartment 720 by breaking the line of weakness 740 to create an opening from the compartment 720.

With continued reference to FIG. 18, the reclosable pouch 700 includes a closure device 750 joined to the front ply 712 and the back ply 714. The closure device 750 is spaced inwardly toward the compartment 720 from the line of weakness 740. Such spacing permits user access to the contents of the compartment 720, and the closure device 750 allows the compartment 720 to be reclosed and stored, or otherwise set aside, if the user does not consume or use all of the contents of the compartment 720. In certain embodiments, the closure device 750 is arranged such that it parallels the line of weakness 740, as seen in FIG. 18. The closure device 750 may be configured in a variety of ways. In certain embodiments, the closure device 750 is a tongue and groove closure. In certain other embodiments, the closure device 750 is a zippered closure.

Although the methods disclosed herein have been described with a particular order of steps, any one or more of the steps may be omitted and/or the order of the steps may be changed without departing from the spirit and the scope of the disclosed methods. Moreover, any one or more of the steps may be carried out manually or via an automated process utilizing various packaging machines and equipment known to those of skill in the art.

It should be understood that the embodiments discussed above are representative of aspects of the invention and are provided as examples and not an exhaustive description of implementations of an aspect of the invention.

While various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention; however, such values and ranges are not to be construed in a limiting sense and are intended to be critical values or ranges only if so expressly stated.

What is claimed is:

1. A web of expandable bags comprising:
a plurality of bags, each bag comprising:
a front ply and a back ply, the front ply joined to the back ply to define a compartment including a first side, a second side, a third side that extends between the first side and the second side, and a bag opening that is configured to be closed; and
a plurality of slits in the front ply and the back ply, wherein the plurality of slits are arranged in a plurality of spaced apart rows;
wherein the plurality of slits allows the compartment to expand in a direction that is perpendicular to the arrangement of the plurality of slits;
wherein each bag is connected to an adjacent bag by a perforated connection.

2. The web of expandable bags of claim 1, wherein the plurality of spaced apart rows of slits are arranged transversely from the first side to the second side.

3. The web of expandable bags of claim 2, wherein the slits in adjacent rows are offset in the transverse direction.

4. The web of expandable bags of claim 1, wherein the plurality of spaced apart rows of slits are arranged longitudinally from the first side to the second side.

5. The web of expandable bags of claim 4, wherein the slits in adjacent rows are offset in the longitudinal direction.

6. The web of expandable bags of claim 1, wherein the plurality of spaced apart rows of slits are arranged at one of an acute angle or an obtuse angle from the first side to the second side.

7. The web of expandable bags of claim 1, wherein the front ply and the back ply comprise a material selected from the group consisting of polyethylene, cellophane, vinyl films, pliofilms, cellulose acetate film, polystyrene, polypropylene, and combinations thereof.

8. The web of expandable bags of claim 1, wherein a top end of each bag is connected to a bottom end of the adjacent bag by the perforated connection.

9. The web of expandable bags of claim 1, wherein the first side of each bag is connected to the second side of the adjacent bag by the perforated connection.

10. A method of forming a web of expandable bags comprising:
providing a web of preformed bags, wherein the web of preformed bags includes a front ply and a back ply, and each preformed bag includes a compartment having a first side, a second side, and a third side that extends between the first side and the second side, and frangible connections that connect adjacent preformed bags; and
forming a plurality of slits in the front ply and back ply of the web of preformed bags, wherein the plurality of slits are arranged in a plurality of spaced apart rows.

11. The method of claim 10, wherein the web of preformed bags is provided on a supply roll.

12. The method of claim 10, wherein the plurality of slits are formed by a cutting module comprising a movable cutter having a plurality of spaced apart cutting blades, a web support for supporting the web of preformed bags as the movable cutter forms slits in the web of preformed bags, and a blower for separating the slit web of preformed bags from the web support.

13. The method of claim 12, further comprising collecting the slit web of preformed bags on a rotatable collection roll.

14. The method of claim 12, further comprising transporting the slit web of preformed bags to a packaging operation.

15. The method of claim 10, wherein the web of preformed bags are connected side-to-side.

16. The method of claim 15, wherein the frangible connections are lines of perforations.

17. The method of claim 10, wherein the web of preformed bags are connected top-to-bottom.

18. The method of claim 17, wherein the frangible connections are lines of perforations.

19. The method of claim 10, wherein the plurality of spaced apart rows of slits are arranged transversely from the first side to the second side.

20. The method of claim 10, wherein the plurality of spaced apart rows of slits are arranged longitudinally from the first side to the second side.

21. The method of claim 10, wherein the web of preformed bags comprise a material selected from the group consisting of polyethylene, cellophane, vinyl films, pliofilms, cellulose acetate film, polystyrene, polypropylene, and combinations thereof.

22. A method of forming an expandable bag containing a product comprising:
providing a supply of connected bags, each bag comprising:
a front ply and a back ply, the front ply joined to the back ply to define a compartment including a first side, a second side, a third side that extends between the first side and the second side, and a bag opening that is configured to be closed;
forming a plurality of slits in the front ply and back ply of each bag of the supply,
wherein the plurality of slits are arranged in a plurality of spaced apart rows;
loading a product into the compartment through the bag opening;
closing the bag opening after the product has been loaded into the compartment; and
separating the closed bag from the supply of bags.

23. The method of claim 22, wherein the bag comprises a material selected from the group consisting of polyethylene, cellophane, vinyl films, pliofilms, cellulose acetate film, polystyrene, polypropylene, and combinations thereof.

24. The method of claim 22, wherein the plurality of spaced apart rows of slits are arranged transversely from the first side to the second side.

25. The method of claim 22, wherein the plurality of spaced apart rows of slits are arranged longitudinally from the first side to the second side.

26. The method of claim 22, wherein the bag opening is closed by heat sealing.

27. A reclosable pouch comprising:
a front ply and a back ply, the front ply joined to the back ply to define a compartment having a perimeter;
a line of weakness in the front ply and the back ply, wherein the line of weakness extends from a first point on the perimeter to a second point on the perimeter, wherein the line of weakness is spaced inwardly toward the compartment from the perimeter; and
a closure device joined to the front ply and the back ply, wherein the closure device is spaced inwardly toward the compartment from the line of weakness.

28. The reclosable pouch of claim 27, wherein the front ply and back ply comprise a material selected from the group consisting of polyethylene, cellophane, vinyl films, pliofilms, cellulose acetate film, polystyrene, polypropylene, and combinations thereof.

29. The reclosable pouch of claim 27, wherein the closure device is a tongue and groove closure.

30. The reclosable pouch of claim 27, wherein the line of weakness is a line of perforations.

31. The reclosable pouch of claim 27, wherein the closure device parallels the line of weakness.
